(19) United States
(12) Patent Application Publication
(10) Pub. No.: US 2013/0235453 A1
(43) Pub. Date: Sep. 12, 2013

(54) DEVICE FOR POSITIONING OPTICAL COMPONENTS ON A MICROSCOPE

(71) Applicants: Klaus Becker, Breitenworbis (DE); Frank Nolte, Bovenden (DE)

(72) Inventors: Klaus Becker, Breitenworbis (DE); Frank Nolte, Bovenden (DE)

(73) Assignee: Carl Zeiss Microscopy GmbH, Jena (DE)

(21) Appl. No.: 13/791,392

(22) Filed: Mar. 8, 2013

(30) Foreign Application Priority Data
Mar. 9, 2012 (DE) 102012004901.3

(51) Int. Cl. G02B 21/00

(52) U.S. Cl. CPC G02B 21/00
USPC 359/381

(57) ABSTRACT

A device for positioning optical components on a microscope, in particular for objectives, filters, beam splitters, mirrors and lenses, comprising a rotatably mounted turret disk with a plurality of openings used for accommodating the optical components and which can be swiveled into the beam path of the microscope. The device further includes a drive motor for producing the rotational movement of the turret disk. A circular, incremental code, which has an index mark for the purpose of referencing, is applied to the turret disk concentrically with respect to the axis of rotation. A reading head, which is matched to the circumference of the turret disk, is used to scan the incremental code and is connected to the drive motor via a control unit.

### RELATED APPLICATIONS

This application claims the benefit of priority to German Patent Application No. 102012004901.3 filed on Mar. 9, 2012. Said application is hereby fully incorporated by reference herein.

### FIELD OF THE INVENTION

The invention relates to positioning optical components on a microscope, in particular for objectives, filters, beam splitters and mirrors, and more specifically relating to a rotatably mounted turret disk with a plurality of openings which are used for accommodating the optical components and which can be swiveled into the beam path of the microscope, and a drive motor for producing the rotational movement of the turret disk.

### BACKGROUND OF THE INVENTION

Devices having a turret for the exact positioning of optical components in the beam path have long been part of a microscope. Accurate positioning with a very high repeat accuracy and long-term stability are a basic condition of such devices.

With manually adjustable turrets, each optical position is typically realized by means of adjustable mechanical notches. These notches work with balls or rollers which are pressed into engagement recesses by means of spring force. This process constitutes a mechanical load and in the course of time leads to inaccuracies due to geometrically worn engagement recesses. As long as the turret movements are only carried out manually, the notch is necessary for manual feedback and leads to the problems described above after a long period of use. An example of such a device with mechanical detents is described in U.S. Pat. No. 7,372,625 B2 hereby fully incorporated herein by reference.

Known motor-operated turrets, however, achieve a considerably higher number of engagement operations in a short time, and therefore also have a shorter service life with accurate positioning. For this reason, there is a multiplicity of solutions for avoiding the mechanical notch.

In a known variant, the engagement process is brought about electromechanically by means of magnets or motors. In doing so, the engagement recesses are less heavily loaded. The relatively high technical complexity and a significantly increased positioning time in these devices are, however, disadvantageous.

Solutions, with which the notch is replaced by magnetic retaining forces, are also known. A significant advantage of such devices is the freedom from wear. This variant, however, can only be used to a limited extent on account of the highly inaccurate positioning.

Positioning controllers are generally needed in order to realize accurate positioning. It is necessary to detect the exact turret position and to hold the turret in this position by means of a control system and motor. In these devices, the detection of the exact position is of decisive importance.

A magnetic field detection system is used, for example, wherein the circumference of the turret is re-polarized line-by-line and evaluated using a magnetic reading head. The costs, and the fact that the surface has to be magnetized, are disadvantageous in this regard.

Optical position detection systems, with which each position is marked by a narrow slot and detected by means of a light barrier, are also known. Coarse positioning by means of an incremental encoder on the motor is typically a feature of these systems. Highly accurate positioning can only be achieved in these devices with difficulty, as practical limits are imposed on the slot width.

A mixture of optical and magnetic methods, with which a preliminary positioning is carried out using an incremental encoder on the motor and the fine positioning takes place with the help of Hall sensors and by forming differences, is also conceivable. With a further known solution, turret and drive form one unit, wherein the turret is the same as the rotor of the drive motor. The control is carried out in a similar way to a stepper motor.

All these known solutions, however, which avoid mechanical engagement operations have the disadvantage that the transmission of force between motor with incremental encoder and turret must be designed rigidly in order to avoid backlash as much as possible. In doing so, the mechanical design is relatively elaborate and complex. Further, the marking of the individual turret positions is unforgiving and requires a great deal of effort. In addition to this, two control circuits are required for the coarse positioning at the motor and for the fine positioning at the turret.

Hence, what is needed in the industry is a device and method for positioning optical components on a microscope in such a way that a backlash-free, highly accurate positioning of optical components with a high positioning speed is possible with a simple mechanical design.

### SUMMARY OF THE INVENTION

Embodiments of the invention address the need in the industry for a device for positioning optical components on a microscope in such a way that a backlash-free, highly accurate positioning of optical components with a high positioning speed is possible with a simple mechanical design.

According to embodiments of the invention, a circular, incremental code, which has an index mark for the purpose of referencing, is applied to the turret disk concentrically with respect to the axis of rotation. A reading head, which expediently is fixed to the microscope stand and which is connected to the drive motor via a control unit, is used to scan the incremental code. The reading head can also be part of the respective components themselves.

Advantageously, the reading head has an interpolated signal output which enables the position of the openings which are used for accommodating optical components to be determined with high accuracy. Further, it is an advantage when the incremental code is in the form of a high-resolution barcode disk and is adhered to the outside diameter of the turret disk. The incremental encoder is therefore part of the turret disk so that the structure is very flat.

In a further advantageous embodiment, the rotational movement of the drive motor is transmitted to the turret disk by means of a toothed belt which enables an almost backlash-free transmission. The solution according to the invention is characterized by a relatively simple mechanical design in the mounting of the turret disk and the force transmission. The determination of position is free from backlash and highly accurate, as measurement is carried out at the scene of events. Because the whole structure only has a low mass, very high positioning speeds can be achieved.

In contrast to the solutions of the prior art, the openings (turret eye rings) for accommodating the optical components can be positioned at any point in the turret disk, as no position has to be permanently marked. The device has virtually no wear. The life is determined only by the bearings of the turret disk, drive motor and toothed belt components. The device according to the invention is described in more detail below with reference to an exemplary embodiment.

In an embodiment, a device for positioning a plurality of optical components on a microscope having a beam path, includes a rotatably mounted turret disk having a plurality of openings, each opening for receiving a separate one of the optical components, the turret disk selectively rotatable about an axis of rotation so that each optical component is positionable in the beam path of the microscope, the turret disk having a incremental code applied thereon concentrically with respect to the axis of rotation. The device further includes a drive motor operably coupled to the turret disk and arranged to rotate the turret disk, a reading head positioned to scan the incremental code, and a control unit communicatively coupled to the reading head and the drive motor, the control unit programmed with an algorithm to selectively operate the drive motor to position the turret disk so that different ones of the optical components are precisely positioned in the microscope beam path according to inputs received from the reading head and a user. The incremental code can be a barcode applied to the outside diameter of the turret disk, and may have a high resolution.

The microscope can include a stand, and the reading head may be coupled to the stand. The reading head can produce a programmable interpolated signal output that is transmitted to the control unit.

In further embodiments, the drive motor can be coupled to the turret disk with a toothed belt. The incremental code on the turret disk may further include an index mark for referencing the position of the turret disk.

In embodiment of the invention, the optical components can include at least one of a lens, an objective, a filter, a beam splitter, or a mirror, or any combination thereof.

In a further embodiment, a microscope having a beam path, can include a device for positioning a plurality of optical components in the beam path of the microscope, the device comprising, a rotatably mounted turret disk having a plurality of openings, each opening for receiving a separate one of the optical components, the turret disk selectively rotatable about an axis of rotation so that each optical component is positionable in the beam path of the microscope, the turret disk having a incremental code applied thereon concentrically with respect to the axis of rotation, a drive motor operably coupled to the turret disk and arranged to rotate the turret disk, a reading head positioned to scan the incremental code, and a control unit communicatively coupled to the reading head and the drive motor, the control unit programmed with an algorithm to selectively operate the drive motor to position the turret disk so that different ones of the optical components are precisely positioned in the microscope beam path according to inputs received from the reading head and a user.

It is understood that the features mentioned above and those yet to be explained below can be used, not only in the stated combinations, but also in other combinations or alone, without departing from the scope of the present invention.

### BRIEF DESCRIPTION OF THE DRAWINGS

The embodiments of the present invention may be more completely understood in consideration of the following detailed description of various embodiments in connection with the accompanying drawings, in which:

FIG. 1 is a schematic representation of a device for positioning optical components on a microscope according to an embodiment of the invention.

While the present invention is amenable to various modifications and alternative forms, specifics thereof have been shown by way of example in the drawings and will be described in detail. It should be understood, however, that the intention is not to limit the present invention to the particular embodiments described. On the contrary, the intention is to cover all modifications, equivalents, and alternatives falling within the spirit and scope of the present invention.

### DETAILED DESCRIPTION OF THE DRAWINGS

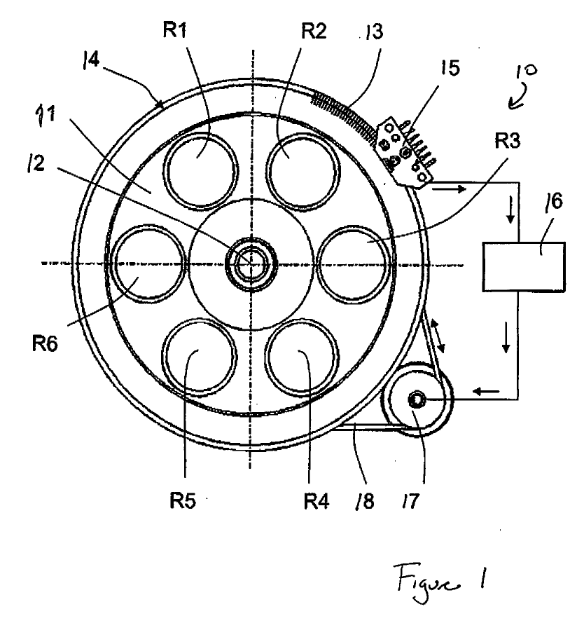

In FIG. 1, there is depicted a device 10 according to an embodiment of the invention. Device 10 generally includes turret disk 11 with six openings (turret eye rings) R1, R2, R3, R4, R5, R6, which are used for accommodating optical components and which are made concentrically and uniformly distributed with respect to the axis of rotation 12 of the turret disk 11. An incremental, high-resolution code 13 in the form of a barcode disk is applied to the outside diameter of the turret disk 11, likewise concentrically with respect to the axis of rotation 12.

In the depicted embodiment, high-resolution code 13 was affixed to the turret disk 11 with adhesive, but other fixing options are also conceivable. An index mark 14 is located on the barcode disk for the purpose of referencing the position of the turret disk 11. The incremental code 13 is scanned by means of a reading head 15 with an interpolated signal output for positioning the turret disk 11. The signals are passed via a control unit 16 to a drive motor 17. The rotational movement of the drive motor 17 is transmitted to the axis of rotation 12 of the turret disk 11 by means of a toothed belt 18 so that the angular location (position) of the turret disk 11 can be varied as required.

In use, device 10 is disposed on a microscope (e.g. as described in U.S. Patent Publication No. 2007/0127116 and U.S. Pat. No. 7,746,553, both of which are hereby fully incorporated herein by reference), proximate the beam path of the microscope so that the optical components received in openings R1, R2, R3, R4, R5, R6, can be selectively interposed in the beam path of the microscope by rotation of turret disk 11. Device 10 can be operably coupled to any part of the microscope as may be desired, including for example the stand of the microscope. Device 10 can be used with any type of microscope known to those skilled in the art. This includes but is not limited to upright and inverted microscopes, laser scanning microscopes, confocal microscopes, stereoscopic microscopes, combination microscopes and microscopic imaging systems. Device 10 can also be used in microscope related structures that are coupled to a microscope such as laser scanners. It will be further appreciated that device 10 can be used to interpose optical components at any location in the beam path of any microscope, and that more than one device 10 could be used to selectively interpose optical components in series in the beam path, or multiple devices 10 could be used to selectively interpose optical components in parallel in microscopes that have more than one beam path.

The foregoing descriptions present numerous specific details that provide a thorough understanding of various embodiments of the invention. It will be apparent to one skilled in the art that various embodiments, having been disclosed herein, may be practiced without some or all of these specific details. In other instances, components as are known to those of ordinary skill in the art have not been described in detail herein in order to avoid unnecessarily obscuring the present invention. It is to be understood that even though numerous characteristics and advantages of various embodiments are set forth in the foregoing description, together with details of the structure and function of various embodiments, this disclosure is illustrative only. Other embodiments may be constructed that nevertheless employ the principles and spirit of the present invention. Accordingly, this application is intended to cover any adaptations or variations of the invention.

For purposes of interpreting the claims for the present invention, it is expressly intended that the provisions of 35 U.S.C. §112(f) are not to be invoked unless the specific terms “means for” or “step for” are recited in a claim.

What is claimed is:

1. A device for positioning a plurality of optical components on a microscope having a beam path, the device comprising:
a rotatably mounted turret disk having a plurality of openings, each opening for receiving a separate one of the optical components, the turret disk selectively rotatable about an axis of rotation so that each optical component is positionable in the beam path of the microscope, the turret disk having a incremental code applied thereon concentrically with respect to the axis of rotation;
a drive motor operably coupled to the turret disk and arranged to rotate the turret disk;
a reading head positioned to scan the incremental code; and
a control unit communicatively coupled to the reading head and the drive motor, the control unit programmed with an algorithm to selectively operate the drive motor to position the turret disk so that different ones of the optical components are precisely positioned in the microscope beam path according to inputs received from the reading head and a user.

2. The device of claim 1, wherein the incremental code is a barcode applied to the outside diameter of the turret disk.

3. The device of claim 1, wherein the incremental code has a high resolution.

4. The device of claim 1, wherein the microscope includes a stand, and wherein the reading head is coupled to the stand.

5. The device of claim 1, wherein the reading head produces a programmable interpolated signal output that is transmitted to the control unit.

6. The device of claim 1, wherein the drive motor is coupled to the turret disk with a toothed belt.

7. The device of claim 1, wherein the incremental code on the turret disk further includes an index mark for referencing the position of the turret disk.

8. The device of claim 1, wherein the optical components include at least one of a lens, an objective, a filter, a beam splitter, or a mirror.

9. A microscope having a beam path, the microscope comprising:
a device for positioning a plurality of optical components in the beam path of the microscope, the device comprising:
a rotatably mounted turret disk having a plurality of openings, each opening for receiving a separate one of the optical components, the turret disk selectively rotatable about an axis of rotation so that each optical component is positionable in the beam path of the microscope, the turret disk having a incremental code applied thereon concentrically with respect to the axis of rotation;
a drive motor operably coupled to the turret disk and arranged to rotate the turret disk;
a reading head positioned to scan the incremental code; and
a control unit communicatively coupled to the reading head and the drive motor, the control unit programmed with an algorithm to selectively operate the drive motor to position the turret disk so that different ones of the optical components are precisely positioned in the microscope beam path according to inputs received from the reading head and a user.

10. The microscope of claim 9, wherein the incremental code is a barcode applied to the outside diameter of the turret disk.

11. The microscope of claim 9, wherein the incremental code has a high resolution.

12. The microscope of claim 9, further comprising a stand, and wherein the reading head is coupled to the stand.

13. The microscope of claim 9, wherein the reading head produces a programmable interpolated signal output that is transmitted to the control unit.

14. The microscope of claim 9, wherein the drive motor is coupled to the turret disk with a toothed belt.

15. The microscope of claim 9, wherein the incremental code on the turret disk further includes an index mark for referencing the position of the turret disk.

16. The microscope of claim 9, wherein the optical components include at least one of a lens, an objective, a filter, a beam splitter, or a mirror.
